(19) United States
(12) Patent Application Publication
(10) Pub. No.: US 2011/0112757 A1
(43) Pub. Date: May 12, 2011

(54) Navigation System and Method Thereof

(75) Inventor: Neng Liu, Hsinchu City (TW)

(73) Assignee: MITAC INTERNATIONAL CORP., Taoyuan (TW)

(21) Appl. No.: 12/871,166

(22) Filed: Aug. 30, 2010

(30) Foreign Application Priority Data
Nov. 10, 2009 (TW) 098138166

(51) Int. Cl. G01C 21/36; G01S 19/42

(52) U.S. Cl. 701/201

(57) ABSTRACT

A navigation system includes a storage module, a positioning module, a time module, and an integration module. The integration module is electrically connected to the storage module, the positioning module and the time module, and compares a navigation keyword with a plurality of landmark names of a map data stored in the storage module. When at least one of the landmark names is found to be partially or completely the same as the navigation keyword and is currently in opening hours, the integration module selects one of these landmark names and creates a navigation path directed to the selected landmark name based on the orientation data of the selected landmark name, positioning information output by the positioning module, and time information output by the time module. A navigation method implemented based on the above navigation system is also disclosed.

### FIELD OF THE INVENTION

The present invention relates to a navigation system and method thereof, and more particularly to a navigation system and method thereof that also considers the opening hours of a landmark when planning a navigation path directed to the landmark.

### BACKGROUND OF THE INVENTION

The global navigation satellite system (GNSS) is now a communication device having been widely employed by the general public in their daily life. With the GNSS, a user needs only to input a navigation keyword indicating a desired destination, and the GNSS will plan a navigation path according to the input navigation keyword. The GNSS can provide the user more conveniences when it works coordinately with a voice reminding system.

However, the currently available navigation system can only provides the user with data about maps, roads, traffic conditions, and orientations in relation to the landmarks to which the user is interested in. There is not any information about the opening hours of different landmarks. In fact, not all the landmarks are in 24-hour opening. The currently available navigation system neither provides any information about changes in the opening hours of different landmarks during some specific time periods. For instance, the toll gates on freeways might stop collecting toll during some special occasions, such New Year holidays or some other consecutive holidays; and some stores would close in some specific time periods. When the navigation system creates a navigation path directing the user to go to a landmark that does not operate at all or arrive at the landmark after the opening hours thereof, it would obviously cause inconvenience to the user. In other words, the current navigation system fails to provide the user with information about the opening hours of different landmarks or changes in the opening hours of these landmarks in some specific days.

For example, when a currently available navigation system plans a navigation path, it first receives a user-input navigation keyword, such as a gas station, and then lists all the landmarks satisfying the navigation keyword “gas station”. However, since the navigation system does not provide information about the opening hours of these gas stations, it is possible the user is guided to a gas station that does not operate when the user arrives at the gas station.

It is therefore necessary to develop a navigation system and method capable of providing the user with information about landmarks that match the navigation keyword and would be in opening hours when the user arrives thereat.

### SUMMARY OF THE INVENTION

A primary object of the present invention is to provide a navigation system and method thereof that avoids a user from getting to or arriving at a designated landmark when the landmark is not in opening hours, and further helps the user to get real-time road-condition information of roads to the designated landmark when the landmark operates during a specific time period.

To achieve the above and other objects, the navigation system according to the present invention includes a storage module, a positioning module, a time module, and an integration module. The integration module is electrically connected to the storage module, the positioning module and the time module, and compares a navigation keyword with a plurality of landmark names of a map data stored in the storage module. When at least one of the landmark names is found to be partially or completely the same as the navigation keyword and is currently in the opening hours thereof, the integration module selects one of these landmark names and creates a navigation path directed to the selected landmark based on the orientation data of the selected landmark name, positioning information output by the positioning module, and time information output by the time module.

In an embodiment of the present invention, the navigation system further includes a real-time road-condition module for receiving a wireless modulated signal output by a wireless frequency-modulated real-time road condition broadcasting system, and demodulating the wireless modulated signal to generate real-time road-condition information.

In the above embodiment, the integration module plans the navigation path not only based on the orientation data of the selected landmark name and the positioning information, but also the real-time road-condition information.

According to the navigation system of the present invention, when any of the landmark names has opening hours not matching time information output by the time module, the landmark name is disabled. When the integration module compares the navigation keyword with the landmark names of the map data, the disabled landmark name is not compared with the navigation keyword even if it is partially or completely the same as the navigation keyword. Thus, the navigation path can be more accurately planned.

To achieve the above and other objects, the navigation method according to the present invention includes the following steps: establishing a map data; receiving positioning information from a positioning module; receiving time information from a time module; using an input module to input a navigation keyword to an integration module; the integration module comparing the navigation keyword with a plurality of landmark names of the map data; locating at least one of the landmark names that is partially or completely the same as the navigation keyword and is currently in the opening hours thereof, and selecting one of the landmark names that is partially or completely the same as the navigation keyword and is currently in the opening hours thereof; creating a navigation path directed to the selected landmark name based on orientation data of the selected landmark name and the positioning information; and using a display to receive and output the navigation path.

According to the present invention, the step of creating the navigation path further includes the following steps: using a real-time road-condition module to generate real-time road-condition information; and the integration module planning the navigation path based on the orientation data of the selected landmark name, the positioning information, and the real-time road-condition information.

With the above arrangements, the navigation system and method thereof according to the present invention has one or more of the following advantages:

(1) By providing the opening-hours data corresponding to each of the landmark names, any landmark name that is partially or completely the same as the navigation keyword but is currently not in opening hours would not be compared with the navigation keyword when the navigation system is planning the navigation path. Therefore, the created navigation path is more practical for the user.

(2) By providing the real-time road-condition module to generate the real-time road-condition information, the integration module can further use the real-time road-condition information and the opening-hours data corresponding to the landmark names at the same time in planning the navigation path. Thus, the navigation system can properly modify a previously planned navigation path when the driving time is too long or the traffic condition is bad such that the user would arrive at the selected landmark name after the opening hours thereof.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a navigation system according to an embodiment of the present invention;

FIG. 2 shows an example of a navigation path created by the navigation system of the present invention; and

FIG. 3 is a flowchart showing the steps included in a navigation method according to the present invention.

### DETAILED DESCRIPTION OF THE PREFERRED EMBODIMENTS

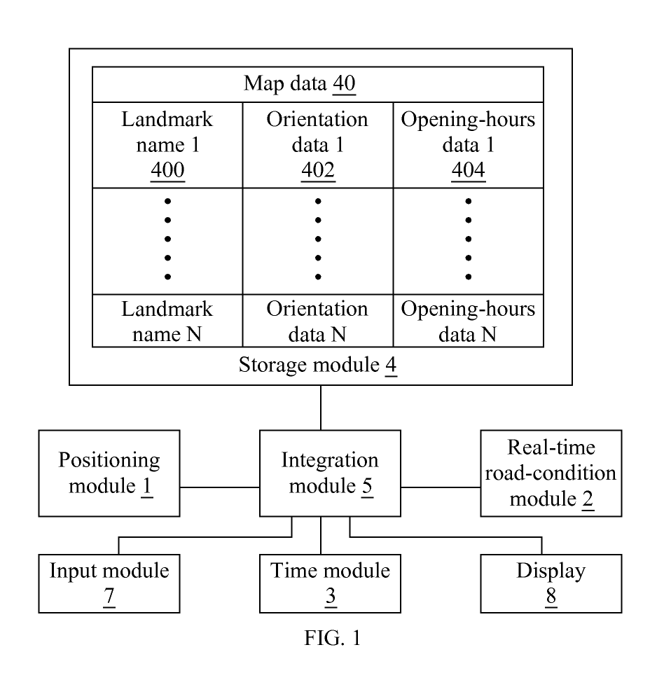

Please refer to FIG. 1 that is a block diagram of a navigation system according to an embodiment of the present invention. As shown, the navigation system includes a positioning module 1, a real-time road-condition module 2, a time module 3, a storage module 4, and an integration module 5.

The positioning module 1 receives positioning signals output by a plurality of positioning satellites and generates positioning information based on the received positioning signals. The real-time road-condition module 2 receives a wireless modulated signal output by a real-time road condition broadcasting system and demodulates the received wireless modulated signal to generate real-time road-condition information. The time module 3 receives satellite signals output by positioning satellites and generates time information from the received satellite signals. Alternatively, the time module 3 allows a user to set user-defined time information. The storage module 4 stores a map data 40 therein. The map data 40 includes a plurality of landmark names 400, a plurality of orientation data 402 separately corresponding to the landmark names 400, and a plurality of opening-hours data 403 separately corresponding to the landmark names 400.

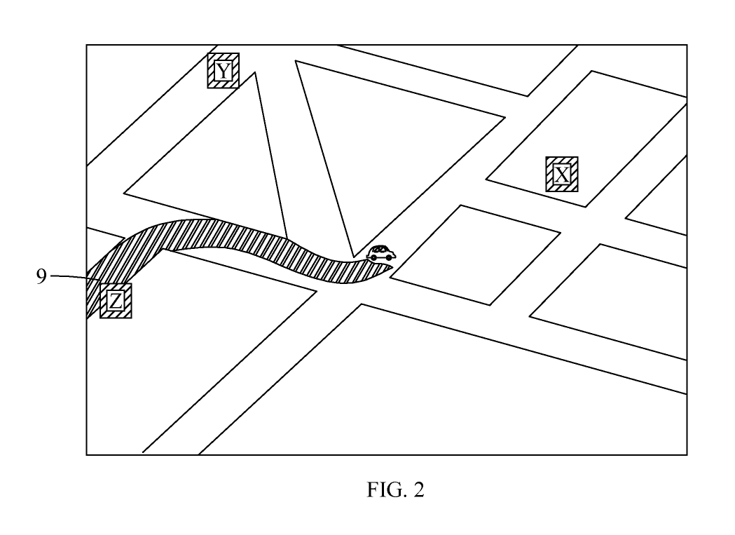

The integration module 5 is electrically connected to the positioning module 1, the real-time road-condition module 2, the time module 3, and the storage module 4. The integration module 5 receives a navigation keyword, and compares the navigation keyword with the landmark names 400 stored in the storage module 4, so as to locate at least one landmark name 400 that is partially or completely the same as the navigation keyword and is currently in the opening hours thereof. The integration module 5 further creates a navigation path 9 (see FIG. 2) leading to a selected landmark name 400 based the orientation data 402 corresponding to the selected landmark name 400 and related positioning information output by the positioning module 1.

According to an embodiment of the navigation system of the present invention, when any of the landmark names 400 has opening hours 404 not matching the time information, the landmark name 400 is disabled. In this manner, the landmark name that is currently not in the opening hours is excluded from the list of landmark names to shorten the time needed to compare the landmark names with the navigation keyword and increase the accuracy in planning the navigation path. Of course, the disabled landmark name can still be enabled again once its opening hours become matched with the time information later, and be compared with the navigation keyword.

The real-time road-condition module 2 receives a wireless modulated signal output by a wireless frequency-modulated real-time road condition broadcasting system, and demodulates the received wireless modulated signal to generate real-time road-condition information. The integration module 5 further uses the orientation data 402 of the selected landmark name 400, the positioning information, and the real-time road-condition information to plan the navigation path 9. That is, the navigation system of the present invention allows a user to more conveniently plan an accurate and practical navigation path according to actual driving speed and traffic conditions on the road, so as to avoid missing the opening hours of the destination due to any traffic jam or slowed driving speed.

When any of the landmark names 400 having an orientation data 402 that matches the real-time road-condition information, the landmark name 400 with that orientation data 402 is disabled. On the other hand, once the orientation data 402 of the disabled landmark name 400 no longer matches the real-time road-condition information, the landmark name 400 is enabled again. In other words, when any of the landmark names 400 in a specific road section in the map data 40 that is partially or completely the same as the navigation keyword and corresponds to the real-time road-condition information, the landmark name 400 will be disabled and not be compared with the navigation keyword, so that the time needed to compare the landmark names with the navigation keyword can be shortened and the navigation path can be more accurately planned.

The navigation system of the present invention further includes an input module 7, such as a touchscreen or a keypad, electrically connected to the integration module 5 for a user to input the navigation keyword via the input module 7. And, a display 8 can be further connected to the integration module 5 for displaying the navigation path 9.

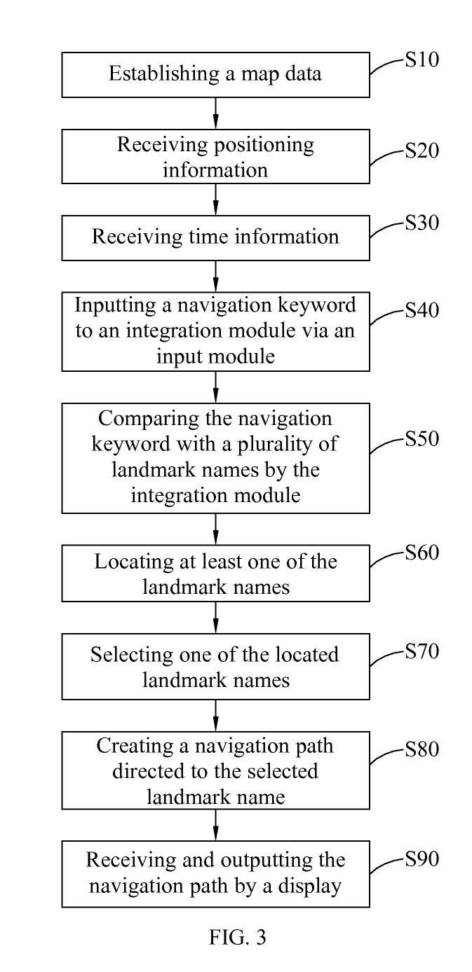

Please refer to FIG. 3 that is a flowchart showing the steps included in a navigation method according to the present invention. The steps include: establishing a map data (S10), the map data being stored in a storage module and including a plurality of landmark names, a plurality of orientation data separately corresponding to the landmark names, and a plurality of opening-hours data separately corresponding to the landmark names; receiving positioning information from a positioning module (S20); receiving time information from a time module (S30); inputting a navigation keyword to an integration module via an input module (S40); the integration module comparing the navigation keyword with the plurality of landmark names (S50); locating at least one landmark name that is partially or completely the same as the navigation keyword and is currently in the opening hours thereof (S60); in the event of having more than one landmark name that is partially or completely the same as the navigation keyword and is currently in the opening hours, selecting one of these landmark names (S70); creating a navigation path directed to the selected landmark name based on the orientation data corresponding to the selected landmark name and the positioning information (S80); and using a display to receive and output the navigation path (S90).

The step S20 of the navigation method according to the present invention further includes the steps of using the positioning module to receive positioning signals output by a plurality of positioning satellites and generating the positioning information based on the received positioning signals. And, the step S30 further includes the steps of using the time module to receive satellite signals output by the positioning satellites and generating the time information from the satellite signals or allowing a user to set user-defined time information.

And, between the step S40 and the step S50 of the navigation method according to the present invention, there are further included the steps of using a real-time road-condition module to receive a wireless modulated signal output by a wireless frequency-modulated real-time road condition broadcasting system, and demodulating the wireless modulated signal to generate real-time road-condition information. Further, the step S50 further includes the step of planning the navigation path based on the orientation data of the selected landmark name, the positioning information, and the real-time road-condition information.

According to the navigation method of the present invention, when any of the landmark names having an orientation data that matches the real-time road-condition information, the landmark name with that orientation data is disabled; and when any of the landmark names has opening hours not matching the time information, the landmark name is disabled; and the disabled landmark names can still be enabled again once their opening hours become matched with the time information later.

For example, as shown in FIG. 2, which schematically shows a navigation path 9 created by the navigation system of the present invention, when the navigation system receives a navigation keyword “gas station” input by a user at a road section A at 3:00 am, the navigation system will use the landmark names in the map data and the orientation data and the opening-hours data corresponding to the landmark names to locate gas stations x, y and z that are located within 10 km from the road section A. It is found by the navigation system the gas station x is not in the opening hours, the gas station y has the orientation data matching the real-time road-condition information, and the gas station z is in the opening hours and does not match any real-time road-condition information. Therefore, the navigation system will plan a navigation path 9 with the user's current location, i.e. the road section A, as a starting point and the gas station z as a destination. Of course, since the gas station x and the gas station y are not in the opening hours and matches the real-time road-condition information, respectively, they can be disabled in advance and are not compared with the navigation keyword “gas station” at all, so that a navigation path directed to the gas station z can be directly planned.

In brief, according to the navigation system and method of the present invention, landmark names and the orientation data and opening-hours data corresponding thereto are used together with time information or further with real-time road-condition information in planning a navigation path directed from a starting point to a landmark name (i.e. a destination) that is currently in the opening hours and not located at a specific road section matching the real-time road-condition information, so that the user would not arrive at the destination after the opening hours thereof or fail to arrive at a destination in the opening hours thereof due to traffic jam. Therefore, an accurate navigation path can be planned by the navigation system and method of the present invention.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A navigation system, comprising:
a storage module having a map data stored therein, the map data including a plurality of landmark names, a plurality of orientation data separately corresponding to the landmark names, and a plurality of opening-hours data separately corresponding to the landmark names;
a positioning module provided for outputting positioning information;
a time module provided for outputting time information;
an integration module being electrically connected to the storage module, the positioning module, and the time module for comparing a navigation keyword with the plurality of landmark names; such that when at least one of the landmark names is found to be partially or completely the same as the navigation keyword and is currently in the opening hours thereof, the integration module selects one of these landmark names and creates a navigation path based on the orientation data of the selected landmark name and the positioning information;
a display being electrically connected to the integration module for displaying the navigation path; and
an input module being electrically connected to the integration module for inputting the navigation keyword to select one of the landmark names that is partially or completely the same as the navigation keyword and is currently in the opening hours thereof.

2. The navigation system as claimed in claim 1, wherein the positioning module receives positioning signals output by a plurality of positioning satellites and generates the positioning information according to the positioning signals.

3. The navigation system as claimed in claim 1, wherein any of the landmark names that has opening hours not matching the time information is disabled.

4. The navigation system as claimed in claim 3, wherein the disabled landmark name is enabled again when the opening hours of the disable landmark name become matching the time information later.

5. The navigation system as claimed in claim 1, further comprising a real-time road-condition module for receiving a wireless modulated signal output by a wireless frequency-modulated real-time road condition broadcasting system, and demodulating the wireless modulated signal to generate real-time road-condition information.

6. The navigation system as claimed in claim 5, wherein the integration module plans the navigation path not only based on the orientation data of the selected landmark name and the positioning information, but also the real-time road-condition information.

7. The navigation system as claimed in claim 5, wherein any of the landmark names that has orientation data matching the real-time road-condition information is disabled.

8. The navigation system as claimed in claim 7, wherein the disabled landmark name is enabled again when the orientation data of the disable landmark name no longer matches the real-time road-condition information.

9. A navigation method, comprising the following steps:
establishing a map data and storing the map data in a storage module; the map data including a plurality of landmark names, a plurality of orientation data separately corresponding to the landmark names, and a plurality of opening-hours data separately corresponding to the landmark names;
receiving positioning information from a positioning module;
receiving time information from a time module;
inputting a navigation keyword to an integration module by an input module;
comparing the navigation keyword with the plurality of landmark names by the integration module;
locating at least one of the landmark names that is partially or completely the same as the navigation keyword and is currently in the opening hours thereof; and selecting one of the landmark names that is partially or completely the same as the navigation keyword and is currently in the opening hours thereof;
creating a navigation path directed to the selected landmark name based on the orientation data of the selected landmark name and the positioning information; and
receiving and outputting the navigation path by a display.

10. The navigation method as claimed in claim 9, wherein further comprising the steps of:
receiving positioning signals output by a plurality of positioning satellites by the positioning module; and
generating the positioning information based on the positioning signals.

11. The navigation method as claimed in claim 9, wherein when any of the landmark names has orientation data matching the real-time road-condition information, the landmark name is disabled.

12. The navigation method as claimed in claim 11, wherein the disabled landmark name is enabled again when the opening hours of the disable landmark name become matching the time information later.

13. The navigation method as claimed in claim 9, wherein the step of creating the navigation path further comprising the following steps of:
using a real-time road-condition module to receive a wireless modulated signal output by a wireless frequency-modulated real-time road condition broadcasting system;
demodulating the wireless modulated signal to generate real-time road-condition information; and
planning the navigation path based on the orientation data of the selected landmark name, the positioning information, and the real-time road-condition information by the integration module.

14. The navigation method as claimed in claim 13, wherein when any of the landmark names has orientation data matching the real-time road-condition information, the landmark name is disabled.

15. The navigation method as claimed in claim 14, wherein the disabled landmark name is enabled again when the orientation data of the disable landmark name no longer matches the real-time road-condition information.
